(19) United States
(12) Patent Application Publication
(10) Pub. No.: US 2002/0001653 A1
(43) Pub. Date: Jan. 3, 2002

(54) Soy doughnut fried in grapeseed oil

(76) Inventor: George B. Diamond, Glen Gardner, NJ (US)

Correspondence Address: OSTROLENK FABER GERB & SOFFEN, 1180 AVENUE OF THE AMERICAS, NEW YORK, NY, 100368403

(21) Appl. No.: 09/767,343

(22) Filed: Jan. 22, 2001

Related U.S. Application Data
(60) Provisional application No. 60/178,843, filed on Jan. 27, 2000.

(51) Int. Cl. A23L 1/00

(52) U.S. Cl. 426/549; 426/438

(57) ABSTRACT

A fried doughnut which includes a fried mixture of an edible product, such as, mixtures of soy product, corn, potato and grapeseed oil.

### RELATED APPLICATIONS

This application is based on and claims priority to U.S. Provisional Application Ser. No. 60/178,843, filed Jan. 27, 2000 and entitled “SOY DOUGHNUT FRIED GRAPESEED OIL”.

### BACKGROUND OF THE INVENTION

The present invention relates to healthful food products and, more particularly, to soy doughnuts fried in grapeseed oil.

Both soy products and grape seed oil are known to improve health inasmuch as soy contains isoflavones among other constituents. Isoflavones are known to ameliorate and help to prevent certain cancers, especially breast cancer and prostate cancer, and grape seed oil has the highest polyunsaturated and lowest saturated oil content of all the common edible oils as well as one of the most powerful antioxidants known and therefore helps to prevent artery clogging and oxidative (free radical) damage and is therefore useful for both heart and artery problems and other damage caused by free radicals.

The problem is how to consume adequate quantities of both ingredients since a substantial intake is required to achieve benefits. Crisps, as described in U.S. Pat. No. 5,997,935, “CRISP FRIED IN GRAPESEED OIL”, the entire disclosure of which is incorporated by reference herein, when eaten in the usual quantities should provide a substantial portion. It has, however, occurred to the inventors that doughnuts of various types such as plain, with fruit centers, crullers, chocolate covered, sugared and so on, are also consumed in large quantities.

Accordingly, it is an object of the present invention to provide a soy doughnut fried in grapeseed oil.

### DETAILED DESCRIPTION OF THE PREFERRED EMBODIMENTS

All the ingredients except the grapeseed oil are blended together in a mixing apparatus, such as is commonly used for such purposes, and then rolled into the desired doughnut size, shape and thickness.

The doughnuts are then deep fried in the grapeseed oil; the frying temperature is adjusted between 340° F.-480° F. to control the time of frying and to control the amount of oil absorbed. Since grapeseed oil has the highest smoke point and flash point of all the oils suitable for commercial frying it is possible to control the amount of fat absorbed by increasing the frying temperature to just below the smoke point and maintain safety against ignition of the oil since its ignition temperature (open flash point) is 625° F. With a smoke point of 485° F. and an ignition (flash) point of 625° F. grapeseed oil is unique in allowing a very high temperature for frying.

Although grapeseed oil by its composition is the healthiest commercial fat available, nevertheless, the fat content of doughnuts should be adjusted to provide the desired fat intake. This is difficult to achieve if the frying temperature has to be kept relatively low.

The invention therefore allows the use of a desirable food oil for frying doughnuts which are made from healthful ingredients, while at the same time making it possible to control the total fat content over a wide range.

Controlling the proportion of soy protein and grapeseed oil in a doughnut which is a food generally consumed in large quantities is a major contribution in the manufacture of health enhancing food products. Further, the substitution of this doughnut for conventional doughnuts will also have a substantial health enhancing effect.

The term “soy flour” as used herein includes various products such as, soy flour, low fat soy flour, enhanced protein soy flour and high protein low fat soy flour. The term “soy product” as used herein includes the above described soy flour, isolated soy protein and processed soybeans. The term “edible product” as used herein means the main ingredients of a doughnut excluding grapeseed oil.

The following are examples of formulations for ordinary doughnuts. The percentages are percentages by weight.

### DOUGH COMPOSITION

### EXAMPLE 1

| ORDINARY DOUGHNUTS | |
|---|---|
| 2 Eggs (or Egg Substitute) | 6% |
| Sugar | 16% |
| Milk | 17% |
| Shortening | 5% |
| Soy Flour | 50% |
| Baking Powder | 5% |
| Salt and Flavors | 1% |
| | 100% |

### DOUGH COMPOSITION

### EXAMPLE 2

| ORDINARY DOUGHNUTS | |
|---|---|
| 2 Eggs (or Egg Substitute) | 6% |
| Sugar | 16% |
| Milk | 17% |
| Shortening | 5% |
| Soy Flour | 5-45% |
| Isolated Soy Protein | 45-5% |
| Baking Powder | 5% |
| Salt and Flavors | 1% |
| | 100% |

### DOUGH COMPOSITION

### EXAMPLE 3

| ORDINARY DOUGHNUTS | |
|---|---|
| 2 Eggs (or Egg Substitute) | 6% |
| Sugar | 16% |
| Milk (with or without water) | 17% |
| Shortening | 5% |
| Soy Products | 50% |
| Baking Powder | 5% |
| Flavors | 1% |
| | 100% |

Although examples 1, 2 and 3 are for ordinary doughnuts, any type of doughnut may be made in accordance with the invention. Thus, for example, for sour cream doughnuts, sour cream or sour milk is substituted for the milk. For chocolate doughnuts, melted chocolate or cocoa powder is added to the appropriate dough. Vanilla may also be added. Other additives, such as orange, orange juice, blueberries, cranberries, etc. may also be used.

As with conventional doughnuts, the soy doughnuts may be made by cutting circles instead of rings and adding various preserves between the circles and the edges pressed together. Additionally, they may be made in different shapes.

The soy doughnut can also be made with yeast risen doughs of various compositions to give the desired degree of sponginess, and filled with various ingredients such as custard, preserves or whipped cream.

After the dough is shaped into the desired shape, it is then deep fried. After frying, it may be dipped in boiling water, glazed in various ways, coated with powdered sugar, ground nuts or other powdered or granular materials.

The soy doughnuts should be removed from the frying oil before they are crisp.

Depending on the degree to which the dough is dried before frying, and/or the frying temperature and the frying time, different amounts of the grape seed oil are absorbed. The preferred range is 5% -20% oil absorption. Since much of the water is evaporated either by drying the dough and during frying, the fried doughnut composition can be tailored to have various amounts of soy product and grapeseed oil to suit different tastes and needs for soy protein and grapeseed oil consumption. Soy protein can be varied from about 10% to 60% and grapeseed oil can be varied from about 5% to 30%.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A fried doughnut comprising:
a fried mixture of a soy product and grapeseed oil.

2. A method of making a fried doughnut which comprises frying a soy product in grapeseed oil.

3. A method of making a fried doughnut as in claim 1, wherein the grapeseed oil is at a temperature between 320° F. and 480° F.
